(19) United States
(12) Patent Application Publication
(10) Pub. No.: US 2026/0066984 A1
(43) Pub. Date: Mar. 5, 2026

(54) CONTROL OF VEHICLE-SATELLITE COMMUNICATIONS

(71) Applicant: FCA US LLC, Auburn Hills, MI (US)

(72) Inventors: Priyank Mittal, Bengaluru (IN); Matthew J Mazurek, Auburn Hills, MI (US)

(21) Appl. No.: 18/819,374

(22) Filed: Aug. 29, 2024

(51) Int. Cl. H04B 7/185

(52) U.S. Cl. CPC H04B 7/18513

(57) ABSTRACT

A method for selective communication between a vehicle and a satellite, includes defining an exclusion zone for a transmission from a vehicle to a satellite, before and during the transmission, determining a presence of a living thing within an exclusion zone, and not starting the transmission or terminating the transmission when a living thing is determined to be within the exclusion zone.

### FIELD

The present disclosure relates to a method for controlling communication between a vehicle and a satellite.

### BACKGROUND

Vehicles include communication units from which transmissions are sent to a satellite and from which satellite transmission are received, for various purposes. Transmission from the vehicle communication unit can be in the form of a high-intensity beam. It may be desirable to limit or prevent transmission from a vehicle to a satellite when a living thing is near the vehicle and in the path of the transmission.

### SUMMARY

In at least some implementations, a method for selective communication between a vehicle and a satellite, includes defining an exclusion zone for a transmission from a vehicle to a satellite, before and during the transmission, determining a presence of a living thing within an exclusion zone, and not starting the transmission or terminating the transmission when a living thing is determined to be within the exclusion zone.

In at least some implementations, the exclusion zone moves as a line of transmission between the user terminal and the satellite changes. In at least some implementations, the exclusion zone includes the line of transmission and a predetermined area around the line of transmission. In at least some implementations, the predetermined area around the line of transmission includes an area at an angle of up to twenty degrees relative to the line of transmission. In at least some implementations, the exclusion zone ends a predetermined distance from the vehicle. In at least some implementations, the predetermined distance is up to fifteen feet.

In at least some implementations, determining the presence of a living thing is accomplished with one or more object detection sensors of the vehicle. In at least some implementations, the one or more object detection sensors include one or more of a camera, a radar sensor, a lidar sensor or an ultrasonic sensor. In at least some implementations, the one or more object detection sensors includes a camera that detects a temperature of an object with a field of view of the camera.

In at least some implementations, the exclusion zone does not include an area within the vehicle or a different vehicle near the vehicle.

In at least some implementations, the vehicle includes an output from which the transmission is emitted, and the exclusion zone includes a right circular cone, or truncated cone, centered on a line of transmission extending from the output to the satellite, and having a cone angle of up to twenty degrees. In at least some implementations, the cone has a length of up to fifteen feet from the antenna.

In at least some implementations, the exclusion zone moves as the satellite moves. In at least some implementations, the satellite is a first satellite of a group of satellites and when the transmission begins between the vehicle and the first satellite, the exclusion zone is defined relative to the line of transmission between the user terminal and the first satellite, and when the first satellite is out of communication with the user terminal the transmission changes to a second satellite and the exclusion zone is defined relative to a second line of transmission that is between the second satellite and the user terminal.

In at least some implementations, the vehicle is not moving when the transmission is to be made, and the step of determining the presence of a living thing is accomplished by detecting motion of the living thing.

In at least some implementations, the exclusion zone is a first exclusion zone, and which also includes defining a second exclusion zone for an incoming transmission sent from a satellite to the vehicle, and wherein the incoming transmission is not accepted or is terminated when a living thing is determined to be within the second exclusion zone. In at least some implementations, the second exclusion zone is smaller than the first exclusion zone. In at least some implementations, the second exclusion zone is the same as the first exclusion zone.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a vehicle with a user terminal transmitting to a satellite, showing a person outside of an exclusion zone;

FIG. 2 illustrates the Earth, a group of Low Earth Orbit satellites, and a vehicle.

FIG. 3 is a view similar to FIG. 1 and showing a person within the exclusion zone;

FIG. 4 is a view similar to FIG. 1 and showing a person who is not within the exclusion zone;

FIG. 5 is a view similar to FIG. 1 and showing an object, a truck, within the exclusion zone; and FIG. 6 is a flowchart illustrating an example of a method for controlling communication from a vehicle to a satellite.

### DETAILED DESCRIPTION

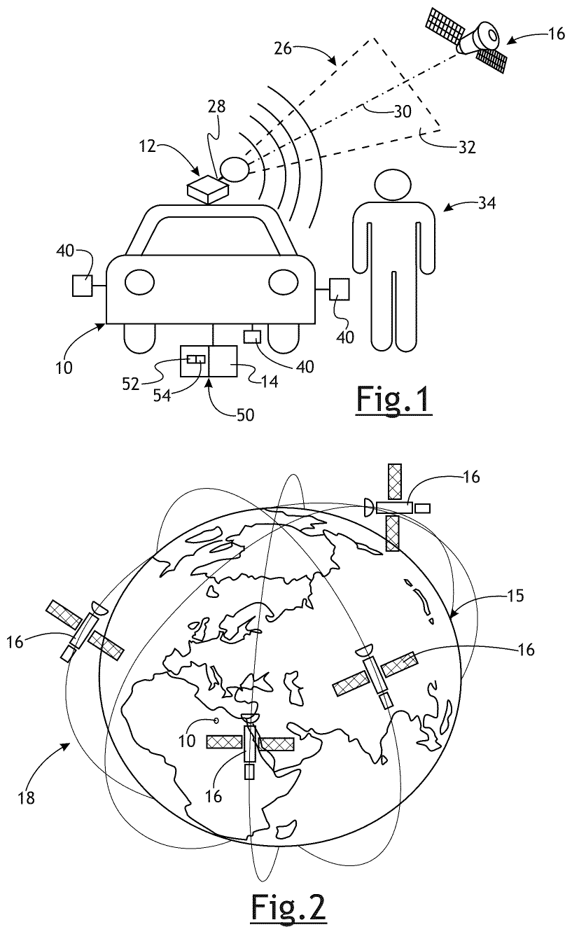

Referring in more detail to the drawings, FIG. 1, shows a vehicle 10 having a telecommunications unit, hereafter referred to as a user terminal 12, by which wireless transmissions are transmitted and received. The transmissions may include various types of data and information, including but not limited to vehicle sensor data transmitted to a backend portion of a cloud-based system (for example, maintained by the vehicle manufacturer), entertainment content such as satellite radio or other streamed content, communications such as cellular phone or video calls which may be controlled and provided via an in-vehicle infotainment system (IVI) 14 or communications for emergency services such as Amber alerts and the like. The transmissions may be of any desired duration, and may be brief, such as few seconds, or of greater length, such as a few hours by way of non-limiting examples. During the transmissions, the vehicle user terminal 12 may be wirelessly coupled to a satellite 16 orbiting the Earth, in known manner.

FIG. 2 is an illustration showing the Earth 15 and several Low Earth Orbit (LEO) satellites 16 that are part of a larger LEO satellite constellation or group 18. LEO satellites orbit the Earth at altitudes that are typically less than about 3,000 km or 1,800 mi. LEO satellites generally orbit much closer to Earth than geosynchronous (GEO) satellites, which are usually at altitudes greater than 30,000 km or about 18,000 mi. Because of their relatively low orbit, LEO satellites tend to quickly move or arc across the sky. A LEO satellite can have an orbital period that is less than 2 hours such that it orbits the Earth more than 10 times per day. Accordingly, a LEO satellite is typically only in communication range with a specific location on Earth for 15-30 minutes per pass.

As shown in FIG. 2, a vehicle user terminal 12 typically has a selection of LEO satellites 16 with which to connect to receive and/or transmit data, and various schemes may be employed to select a satellite 16 for a given connection. Further, a vehicle 10 may connect with different satellites, over time, as satellites move out of and into a connection area with the vehicle 10 (where the connection area may be a field of view of the user terminal 12 in which the user terminal 12 may connect with a given satellite 16). For example, for streamed satellite music, the vehicle 10 may connect and disconnect from individual satellites that pass into and out of the connection area, via a process called satellite handovers, for continuous play of the music in the vehicle 10 over some duration of time. There are various known ways used to determine which satellite to connect to and when and how to conduct satellite handovers.

Transmissions from the vehicle user terminal 12 to a satellite 16 can include relatively narrow, high-intensity radiation beams. While the radiation from such user terminals may be non-ionizing, it may be desirable to inhibit or prevent transmissions when a living thing is in the path of a transmission. The living thing may be a person and, in at least some implementations, also an animal.

FIG. 6 shows a flowchart of a method 20 for selective communication between a vehicle 10 and a satellite 16. In step 22, it is determined if a transmission is to be sent from the user terminal 12 to a satellite 16. If so, the method proceeds to step 24 in which an exclusion zone 26 is defined. As noted later, when a living thing is detected in the exclusion zone 26, a transmission is not started or an ongoing transmission is interrupted or terminated.

The exclusion zone 26 may be defined as an area in which higher intensity radiation is associated with the transmission. In at least some implementations, the user terminal 12 includes an antenna or other output 28 via which transmissions are received and emitted/outputted from the user terminal 12. The exclusion zone 26 may begin at the antenna or other output 28 of the user terminal 12, and continue for a predetermined distance in the direction of a line of transmission 30 (shown in FIGS. 1, 3, 4 and 5) between the user terminal 12 and a satellite 16 that receives or will receive the transmission.

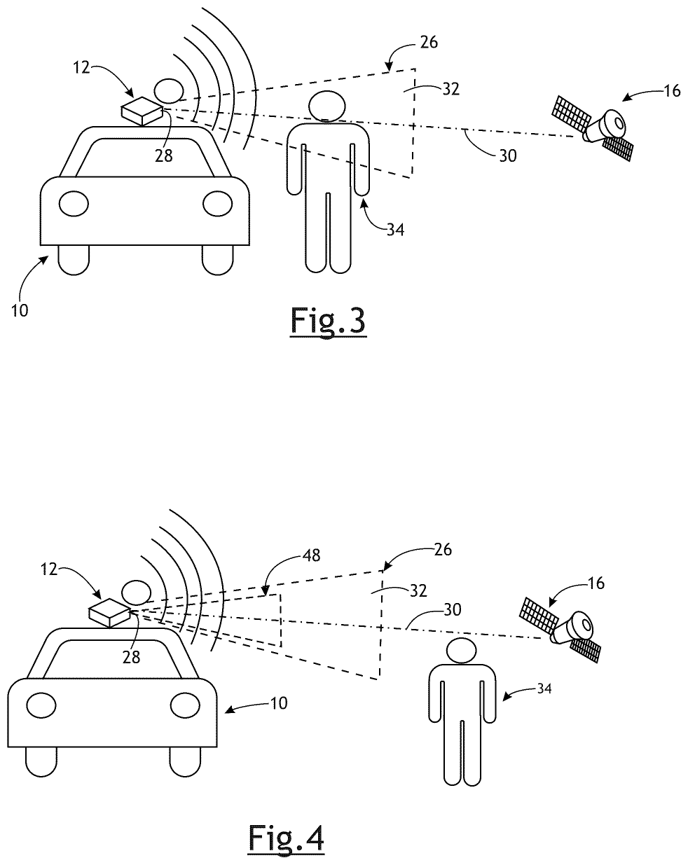

In at least some implementations, the exclusion zone 26 includes the line of transmission 30 between the user terminal 12 (e.g. an antenna or other output of the user terminal 12) and the satellite 16, and a predetermined area 32 around the line of transmission 30. While shown as a straight line, the line of transmission 30 may be arcuate or otherwise defined to mimic a direction of travel of a transmission beam output from the user terminal 12. The predetermined area 32 around the line 30 may include an area at an angle of up to twenty degrees, with some implementations using an area at an angle of up to eight degrees, from the line 30 and starting at the output 28 of the user terminal 12 (e.g. the point or region of transmission from the vehicle 10), as diagrammatically shown by the area within the dashed line polygon in FIG. 1. In this way, the exclusion zone 26 may be conical (e.g. a right circular cone) or a truncated cone and the length of the cone or truncated cone may end at a predetermined distance from the output/antenna 28 of the user terminal 12. In at least some implementations, the predetermined distance is up to fifteen feet from the antenna 28, with some implementations limiting the distance to up to ten feet. Thus, a person 34 or other living thing that is within the direction of the transmission (the line of transmission 30 and area 32 around the line 30) and within predetermined distance, as shown in FIG. 3, is within the exclusion zone 26 while a person 34 farther from the vehicle 10 than the predetermined distance is not within the exclusion zone 26, as shown in FIG. 4.

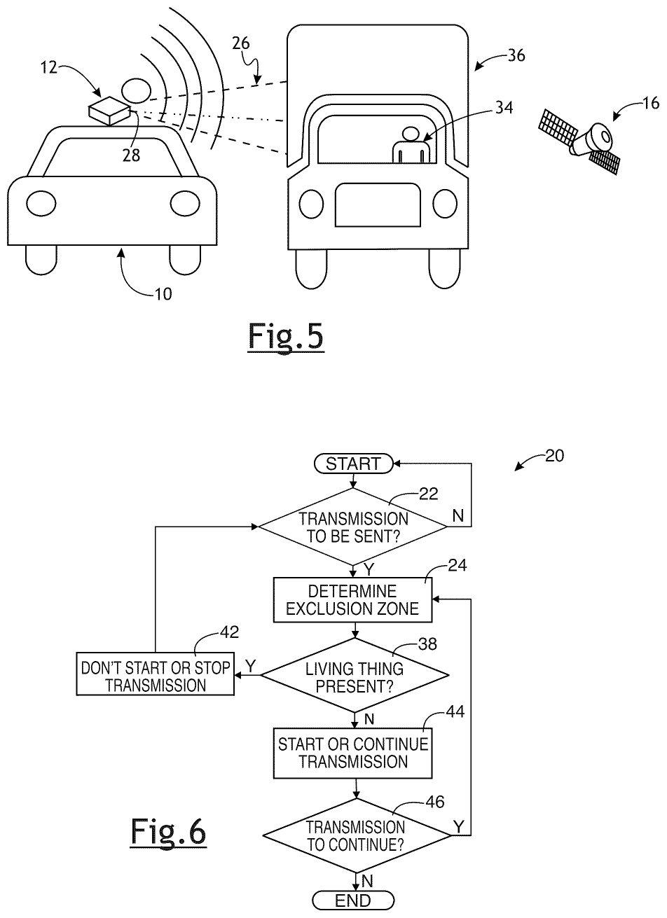

In at least some implementations, the exclusion zone 26 does not include an area within the vehicle 10 including the user terminal 12 or in a different vehicle 36 (FIG. 5) near the vehicle 10 including the user terminal 12, because, for example, a vehicle 10, 36 may shield living things inside the vehicle. Further, the line of transmission 30 between the user terminal 12 and a satellite 16 will move as the satellite 16 moves. Thus, the exclusion zone 26 moves as the satellite 16 moves. The exclusion zone 26 also moves or changes when the user terminal 12 disconnects from one satellite and connects with another satellite (e.g. after a satellite handover from a first satellite to a second satellite in a group of satellites). Still further, the vehicle 10 may also move and the exclusion zone 26 also will move as the vehicle 10, and hence, the user terminal 12 moves. Thus, the exclusion zone 26 is always moving and is dynamically determined to maintain the exclusion zone 26 relevant to the line or transmission between the user terminal 12 and satellite 16. A person previously determined to be within an exclusion zone 26 may not be after some time, and vice versa.

Returning to the method 20 of FIG. 6, in step 38 it is determined if a living thing is present within the exclusion zone 26. This may be done before and during a transmission from the user terminal 12 to the satellite 16. To accomplish this, the vehicle 10 may include one or more object detection sensors 40, as shown in FIG. 1. Representative sensors 40 include cameras, including infrared cameras, radar sensors, lidar sensors and ultrasonic sensors. The sensors 40 may detect motion of a detected object, temperature of a detected object and/or use object recognition techniques to determine the type of object detected. In this case, various living things may be defined and the object recognition techniques may be used to determine if an object detected by a sensor 40 is a living thing based on, for example, the size, shape and physical characteristics of the detected object.

The object recognition features may be done based on images captured by a camera 40 of an object within a field of view of the camera, or by data from reflections received at an object detection sensor 40 (e.g. radar, lidar or ultrasonic sensors that emit waves of light or sound and receive reflections of the emissions). Infrared cameras, for example, may be used to detect a “heat signature” of objects and from the heat signature a determination can be made if a detected object is a living thing. In at least some implementations, the method is performed when the vehicle 10 is not moving when the transmission is to be made or is occurring, and the step of determining the presence of a living thing is accomplished by detecting motion of the living thing. Of course, the vehicle 10 may also be moving as the method 20 is performed, as noted above.

FIG. 1 shows an example in which a person 34 is not within the exclusion zone 26 even though the person 34 is near the vehicle 10, because the line or transmission 30 and related exclusion zone 26 is above the person 34. As noted above, FIG. 3 shows an example in which a person 34 is within the exclusion zone 26, as part of the person is within the exclusion zone 26. FIG. 4 shows an example in which a person 34 is outside of the exclusion zone 26, that is, no part of the person is within the exclusion zone 26. Further, FIG. 5 shows an example in which a non-living object, shown as a truck 36, is within the exclusion zone 26, but a person within the truck 36 is not considered to be in the exclusion zone, as noted above.

Returning to the method 20 of FIG. 6, if in step 38 it was determined that a living thing is within the exclusion zone 26, the method proceeds to step 42. In step 42, the transmission is either not started, or if the transmission is already in progress, the transmission is terminated. Thereafter, the method loops back to step 22 to determine if the transmission is still to be sent, and if so, to determine the exclusion zone 26 and if a living thing is within the new exclusion zone 26.

If in step 38 it was determined that a living thing is not within the exclusion zone 26, the method proceeds to step 44 in which the transmission is started or permitted to continue. From step 44, the method may proceed to step 46 in which it is determined if the transmission is continuing. If not, then the method may end. If the transmission is continuing, then the method loops back to step 24 to determine the exclusion zone 26 (which moves, as noted above), and then to repeat the other steps noted above. In this way, the method 20 may be run before a transmission is started and also continually when a transmission is in progress to permit termination of the transmission if a living thing is later detected within the exclusion zone 26.

The preceding discussion related to transmission from the user terminal 12 to a satellite 16. In at least some implementations, the method may also be performed before or during a transmission from a satellite 16 to the user terminal 12. As the radiation associated with a transmission from a satellite 16 to a vehicle user terminal 12 is lower at and near the vehicle 10, the exclusion zone 26 may be smaller for transmissions received at the vehicle 10. In at least some implementations, such as is shown in FIG. 4, the exclusion zone is a first exclusion zone 26 for transmissions from the user terminal 12 and a second exclusion zone 48 for transmissions received at the user terminal 12. The first and second exclusion zones 26, 48 could be the same but need not be, and as noted herein, the second exclusion zone 48 may be smaller than the first exclusion zone 26. For example, the second exclusion zone 48 may have a shorter distance at which a living object must be detected relative to the vehicle 10, and/or a narrower or lesser angular range relative to the antenna/input to the user terminal 12. When a living thing is detected with the second exclusion zone 48, a transmission from a satellite 16 to the user terminal 12 is either not accepted so that it does not start, or it is terminated if the transmission was already in progress when the living thing was detected in the second exclusion zone 48.

In order to perform the functions and desired processing set forth herein, as well as the computations therefore, the vehicle 12 may include a control system 50 as shown in FIG. 1, that may include, but is not limited to, one or more controller(s) 52, control unit(s), processor(s), computer(s), DSP(s), memory, storage, register(s), timing, interrupt(s), communication interface(s), and input/output signal interfaces, and the like, as well as combinations comprising at least one of the foregoing. For example, the vehicle 10 may include input signal processing and filtering to enable accurate sampling and conversion or acquisitions of such signals from communications interfaces including the user terminal 12 and sensors 40. As used herein the terms control system 50 or controller or the like may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 50 may include or interface with controllers or processors of the IVI system 14, if desired.

The term “memory” 54 or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

With the systems and methods described herein, transmissions between a vehicle user terminal 12 and a satellite 16 can be controlled to limit transmission when living things are within an exclusion zone 26, 48 which may be defined as an area close to the user terminal 12. This reduces exposure of the living thing(s) to radiation from the transmissions and may limit any harm that may occur to the living thing(s) from such radiation/transmissions.

What is claimed is:

1. A method for selective communication between a vehicle and a satellite, comprising:
defining an exclusion zone for a transmission from a vehicle to a satellite;
before and during the transmission, determining a presence of a living thing within an exclusion zone; and
not starting the transmission or terminating the transmission when a living thing is determined to be within the exclusion zone.

2. The method of claim 1 wherein the exclusion zone moves as a line of transmission between the user terminal and the satellite changes.

3. The method of claim 2 wherein the exclusion zone includes the line of transmission and a predetermined area around the line of transmission.

4. The method of claim 3 wherein the predetermined area around the line of transmission includes an area at an angle of up to twenty degrees relative to the line of transmission.

5. The method of claim 3 wherein the exclusion zone ends a predetermined distance from the vehicle.

6. The method of claim 5 wherein the predetermined distance is up to fifteen feet.

7. The method of claim 1 wherein determining the presence of a living thing is accomplished with one or more object detection sensors of the vehicle.

8. The method of claim 7 wherein the one or more object detection sensors include one or more of a camera, a radar sensor, a lidar sensor or an ultrasonic sensor.

9. The method of claim 8 wherein the one or more object detection sensors includes a camera that detects a temperature of an object with a field of view of the camera.

10. The method of claim 1 wherein the exclusion zone does not include an area within the vehicle or a different vehicle near the vehicle.

11. The method of claim 1 wherein the vehicle includes an output from which the transmission is emitted, and the exclusion zone includes a right circular cone, or truncated cone, centered on a line of transmission extending from the output to the satellite, and having a cone angle of up to twenty degrees.

12. The method of claim 11 wherein the exclusion zone moves as the satellite moves.

13. The method of claim 12 wherein the satellite is a first satellite of a group of satellites and when the transmission begins between the vehicle and the first satellite, the exclusion zone is defined relative to the line of transmission between the user terminal and the first satellite, and when the first satellite is out of communication with the user terminal the transmission changes to a second satellite and the exclusion zone is defined relative to a second line of transmission that is between the second satellite and the user terminal.

14. The method of claim 11 wherein the cone has a length of up to fifteen feet from the antenna.

15. The method of claim 1 wherein the vehicle is not moving when the transmission is to be made, and the step of determining the presence of a living thing is accomplished by detecting motion of the living thing.

16. The method of claim 1 wherein the exclusion zone is a first exclusion zone, and which also includes defining a second exclusion zone for an incoming transmission sent from a satellite to the vehicle, and wherein the incoming transmission is not accepted or is terminated when a living thing is determined to be within the second exclusion zone.

17. The method of claim 16 wherein the second exclusion zone is smaller than the first exclusion zone.

18. The method of claim 16 wherein the second exclusion zone is the same as the first exclusion zone.
